(19) United States
(12) Patent Application Publication
(10) Pub. No.: US 2023/0324006 A1
(43) Pub. Date: Oct. 12, 2023

(54) BOTTOM WALL OF A LIQUEFIED GAS STORAGE TANK

(71) Applicant: GAZTRANSPORT ET TECHNIGAZ, Saint Remy Les Chevreuse (FR)

(72) Inventors: Camille GOURMELEN, Saint Remy Les Chevreuse (FR); Thomas KRUMNOW, Saint Remy Les Chevreuse (FR); Erwan MICHAUT, Saint Remy Les Chevreuse (FR); Fabien PESQUET, Saint Remy Les Chevreuse (FR)

(73) Assignee: GAZTRANSPORT ET TECHNIGAZ, Saint Remy Les Chevreuse (FR)

(21) Appl. No.: 18/043,948

(22) PCT Filed: Sep. 8, 2021
(86) PCT No.: PCT/FR2021/051543

§ 371 Date: Mar. 3, 2023

(30) Foreign Application Priority Data
Sep. 11, 2020 (FR) 2009209

(51) Int. Cl. F17C 3/02; F17C 9/00; F17C 6/00

(52) U.S. Cl. CPC F17C 3/027; F17C 9/00; F17C 6/00; F17C 2203/0329; F17C 2203/066; F17C 2205/0103; F17C 2205/0355; F17C 2270/0107; F17C 2201/052; F17C 2201/0157; F17C 2203/0358; F17C 2221/033; F17C 2223/0153; F17C 2260/011; F17C 2270/0121

(57) ABSTRACT

A tank for transporting and/or storing a liquefied gas includes: a plurality of walls, each including, in a direction of the thickness of the wall, a thermally insulating barrier and a leak-tight membrane that rests against the thermally insulating barrier and is intended to be in contact with the liquefied gas inside the tank, the thermally insulating barrier including a plurality of self-supporting heat-insulating panels which each includes a block of polymer foam and a plate, a bottom wall of the plurality of walls includes a first portion at least partially surrounding a second portion of the bottom wall, the second portion including drain. The blocks of polymer foam of the second portion have a density greater than a density of the polymer foam blocks of the first portion.

The present invention relates to the field of tanks suitable for containing a liquefied gas. More particularly, the invention relates to a bottom wall of a tank, for example of a gravity platform, for the storage of a liquefied gas, such as for example liquefied natural gas (LNG).

Gravity platforms are generally an offshore structure used in the context of oil or gas production. These structures often have a concrete base structure, referred to using the term GBS (Gravity Based Structure); the term SGS (Steel Gravity Structure) is also used for a base structure made of steel, to which the invention also applies.

Gravity platforms can simultaneously serve as a bund, storage, platform for receiving a liquefaction plant and loading dock in the context of a field for producing liquefied gas such as, for example, liquefied natural gas or ethane.

The storage tanks of gravity platforms should be optimized for the storage of a liquefied gas. On the one hand, they do not offer enough thermal insulation between the walls of the tank and the concrete base structure of the gravity platform to efficiently store a liquefied gas. On the other hand, gravity platform tanks have a much larger volume than ship tanks and offer only limited, or even insufficient, resistance to the operating loads and accidental loads involved in loading or unloading the tank with liquefied gas.

One objective of the present invention is to overcome at least one of the aforementioned drawbacks and also to lead to other advantages by proposing a novel type of wall for a tank for storing and/or transporting liquefied gas, especially for a gravity platform.

A second objective of the invention is to obtain optimum effectiveness of the pumping of the liquefied gas at the bottom of the tank by minimizing the level of residual liquefied gas.

A third objective of the invention is to minimize manufacturing costs while limiting the manufacturing complexity of such a tank.

The present invention thus proposes a tank for transporting and/or storing a liquefied gas, comprising a plurality of walls, each comprising, in a direction of the thickness of the wall, a thermally insulating barrier and at least one leak-tight membrane that rests against the thermally insulating barrier and is intended to be in contact with the liquefied gas inside the tank, the thermally insulating barrier comprising a plurality of self-supporting heat-insulating panels which each comprise a block of polymer foam and at least one plate, a bottom wall of the plurality of walls comprises at least one first portion at least partially surrounding a second portion of the bottom wall, the second portion comprising at least one drain. The blocks of polymer foam of the second portion have a density greater than a density of the blocks of polymer foam of the first portion.

The surrounding of the second portion of the bottom wall at least partially by the first portion of the bottom wall is viewed in projection in a plane perpendicular to the direction of the thickness of the bottom wall.

In other words, the tank for transporting and/or storing a liquefied gas comprises a bottom wall which comprises at least one drain. The drain is a recess intended to accommodate a suction member of a pump in order to suck in the liquefied gas contained in the tank. As a result, the drain is a portion of the bottom wall, and therefore of the tank, which is under particular strain during the operation of the tank. Thus, by increasing the density of the blocks of polymer foam of the self-supporting heat-insulating panels in the portion comprising the drain with respect to the rest of the bottom wall, the thermal insulation is improved, as is the mechanical strength of the wall.

Herein, as in the rest of the application, “self-supporting panel” is understood to mean that the self-supporting heat-insulating panel can withstand the weight of an object placed on top of it, for example liquefied natural gas, without significantly deforming and within the limit of its mechanical strength.

According to one embodiment, the first portion of the bottom wall lies in a main plane of extension perpendicular to the direction of the thickness of the bottom wall.

According to one embodiment, the second portion of the bottom wall comprises a first part which extends in a main plane of extension perpendicular to the direction of the thickness of the bottom wall, and a second part that extends from a contour of the first part to the first portion.

According to one embodiment, the drain has a cylindrical shape with a square base or with a circular section.

According to one embodiment, the second portion of the bottom wall comprises a plurality of drains.

According to one embodiment, the bottom wall comprises a plurality of second portions.

According to one embodiment, the plurality of walls comprises an upper wall and side walls connecting the bottom wall to the upper wall, a density of the blocks of polymer foam of the self-supporting heat-insulating panels decreasing from the bottom wall to the upper wall.

According to one embodiment, the density of the blocks of polymer foam of the self-supporting heat-insulating panels of the first portion is substantially equal to the density of the blocks of polymer foam of the self-supporting heat-insulating panels of the side walls and is substantially equal to the density of the blocks of polymer foam of the self-supporting heat-insulating panels of the upper wall.

“Substantially” should be understood herein, as well as in the following, to mean that manufacturing tolerances, as well as possible assembly tolerances, must be taken into account.

According to one embodiment, the tank comprises a first zone formed by the bottom wall and by a lower part of the side walls, as well as a second zone formed by the upper wall and by an upper part of the side walls, and wherein the density of the blocks of polymer foam of the self-supporting heat-insulating panels of the first zone is greater than the density of the blocks of polymer foam of the self-supporting heat-insulating panels of the second zone.

According to one embodiment, the tank comprises at least one third zone inserted between the first zone and the second zone and wherein the density of the blocks of polymer foam of the self-supporting heat-insulating panels of the third zone is comprised between the density of the blocks of polymer foam of the self-supporting heat-insulating panels of the first zone and the density of the blocks of polymer foam of the self-supporting heat-insulating panels of the second zone.

According to one embodiment, the tank comprises a plurality of third zones, the third zones being stacked in a direction from the bottom wall toward the upper wall, the blocks of polymer foam of the self-supporting heat-insulating panels of one third zone of the plurality of third zones having a substantially identical density, and the density of the blocks of polymer foam of the self-supporting heat-insulating panels of the plurality of third zones decreasing in the direction from the bottom wall toward the upper wall. In other words, the tank comprises at least two third zones that are stacked in a direction from the bottom wall toward the upper wall. Thus, the tank can comprise as many third zones as necessary, such as for example to adapt to different tank sizes. For example, the zone tank may comprise four, five or six third zones. In addition, the density of the blocks of polymer foam of the self-supporting heat-insulating panels is uniform within a single third zone and the density of the blocks of polymer foam of the self-supporting heat-insulating panels is different from one third zone to another third zone.

According to one embodiment, the tank comprises three third zones. Thus, the tank comprises three zones: the first zone, the second zone and the three third zones.

According to one embodiment, the density of the blocks of polymer foam of the self-supporting heat-insulating panels of the third zone closest to the bottom wall is greater than the density of the blocks of polymer foam of the self-supporting heat-insulating panels of the third zone closest to the upper wall.

According to one embodiment, the leak-tight membrane is a primary leak-tight membrane and the thermally insulating barrier is a primary thermally insulating barrier, and wherein the bottom wall comprises a secondary leak-tight membrane and a secondary thermally insulating barrier which comprises a plurality of self-supporting heat-insulating blocks comprising tiles of polymer foam and at least one plate, the secondary leak-tight membrane rests against the secondary thermally insulating barrier, the primary thermally insulating barrier rests against the secondary leak-tight membrane and the primary leak-tight membrane rests against the primary thermally insulating barrier.

Herein, as in the rest of the application, the term “self-supporting block” is understood to mean that the self-supporting heat-insulating block can withstand the weight of an object placed on top of it, for example liquefied natural gas, without significantly deforming and within the limit of its mechanical strength.

According to one embodiment, the tiles of polymer foam of the self-supporting heat-insulating blocks of the first portion, of the side walls and of the upper wall have a density substantially equal to the density of the blocks of polymer foam of the self-supporting heat-insulating panels of the first portion, of the side walls and of the upper wall and wherein the tiles of polymer foam of the self-supporting heat-insulating blocks of the second portion have a density substantially equal to the density of the blocks of polymer foam of the self-supporting heat-insulating panels of the second portion. In this context, it is understood that the tiles of polymer foam and the blocks of polymer foam within a single wall or of a single portion have a substantially equal density, and that the tiles of polymer foam of the first portion, of the side walls and of the upper wall have a substantially equal density, and that the blocks of polymer foam of the first portion, of the side walls and of the upper wall have a substantially equal density.

According to one embodiment, the tiles of polymer foam of the self-supporting heat-insulating blocks of the second portion of the bottom wall have a greater density than the tiles of polymer foam of the self-supporting heat-insulating blocks of the first portion of the bottom wall.

According to one embodiment, the tiles of polymer foam of the self-supporting heat-insulating blocks of the first portion of the bottom wall have a density substantially equal to the density of the blocks of polymer foam of the self-supporting heat-insulating panels of the first portion of the bottom wall.

According to one embodiment, the tiles of polymer foam of the self-supporting heat-insulating blocks of the second portion of the bottom wall have a density substantially equal to the density of the blocks of polymer foam of the self-supporting heat-insulating panels of the second portion of the bottom wall.

According to one embodiment, the density of the tiles of polymer foam of the self-supporting heat-insulating blocks of the first portion is substantially equal to the density of the tiles of polymer foam of the self-supporting heat-insulating blocks of the side walls and is substantially equal to the density of the tiles of polymer foam of the self-supporting heat-insulating blocks of the upper wall.

According to one embodiment, the density of the blocks of polymer foam of the self-supporting heat-insulating panels of the first portion of the bottom wall is less than or equal to 110 kg/m³.

According to one embodiment, the density of the blocks of polymer foam of the self-supporting heat-insulating panels of the second portion of the bottom wall is greater than or equal to 115 kg/m³.

According to one embodiment, the plurality of walls comprises an upper wall and side walls connecting the bottom wall to the upper wall, and wherein the upper wall and the side walls each comprise a secondary leak-tight membrane and a secondary thermally insulating barrier which comprises a plurality of self-supporting heat-insulating blocks comprising tiles of polymer foam and at least one plate, the secondary leak-tight membrane rests against the secondary thermally insulating barrier, the primary thermally insulating barrier rests against the secondary leak-tight membrane and the primary leak-tight membrane rests against the primary thermally insulating barrier, a density of the tiles of polymer foam of the self-supporting heat-insulating blocks decreasing from the bottom wall to the upper wall.

According to one embodiment, the tank comprises a first zone formed by the bottom wall and by a lower part of the side walls, as well as a second zone formed by the upper wall and by an upper part of the side walls, and wherein the density of the tiles of polymer foam of the self-supporting heat-insulating blocks of the first zone is greater than the density of the tiles of polymer foam of the self-supporting heat-insulating blocks of the second zone.

According to one embodiment, the tank comprises at least one third zone inserted between the first zone and the second zone and wherein the density of the tiles of polymer foam of the self-supporting heat-insulating blocks of the third zone is comprised between the density of the tiles of polymer foam of the self-supporting heat-insulating blocks of the first zone and the density of the tiles of polymer foam of the self-supporting heat-insulating blocks of the second zone.

According to one embodiment, the tank comprises a plurality of third zones, the third zones being stacked in a direction from the bottom wall toward the upper wall, the tiles of polymer foam of the self-supporting heat-insulating blocks of one third zone of the plurality of third zones having a substantially identical density, and the density of the tiles of polymer foam of the self-supporting heat-insulating blocks of the plurality of third zones decreasing in the direction from the bottom wall toward the upper wall. In other words, the tank comprises at least two third zones that are stacked in a direction from the bottom wall toward the upper wall. Thus, the tank can comprise as many third zones as necessary, such as for example to adapt to different tank sizes. For example, the zone tank may comprise four, five or six third zones. In addition, the density of the tiles of polymer foam of the self-supporting heat-insulating blocks is uniform within a single third zone and the density of the tiles of polymer foam of the self-supporting heat-insulating blocks is different from one third zone to another third zone.

According to one embodiment, the tank comprises three third zones. Thus, the tank comprises three zones: the first zone, the second zone and the three third zones.

According to one embodiment, the density of the tiles of polymer foam of the self-supporting heat-insulating blocks of the third zone closest to the bottom wall is greater than the density of the tiles of polymer foam of the self-supporting heat-insulating blocks of the third zone closest to the upper wall.

According to one embodiment, the density of the tiles of polymer foam of the self-supporting heat-insulating blocks of the first portion of the bottom wall is less than or equal to 110 kg/m³.

According to one embodiment, the density of the tiles of polymer foam of the self-supporting heat-insulating blocks of the second portion of the bottom wall is greater than or equal to 115 kg/m³.

According to one embodiment, the density of the tiles of polymer foam of the self-supporting heat-insulating blocks of the first zone is greater than 70 kg/m³.

According to one embodiment, the density of the blocks of polymer foam of the self-supporting heat-insulating panels of the first zone is greater than 70 kg/m³.

According to one embodiment, the density of the tiles of polymer foam of the self-supporting heat-insulating blocks of the second zone is less than 70 kg/m³.

According to one embodiment, the density of the blocks of polymer foam of the self-supporting heat-insulating panels of the second zone is less than 70 kg/m³.

According to one embodiment, the density of the blocks of polymer foam of the self-supporting heat-insulating panels of the third zone is comprised between 65 kg/m³ and 90 kg/m³.

According to one embodiment, the density of the tiles of polymer foam of the self-supporting heat-insulating blocks of the third zone is comprised between 65 kg/m³ and 90 kg/m³.

It should be understood herein, as well as in all the following, that it is necessary to take into account any manufacturing tolerances with respect to the numerical values given to the densities of the blocks of polymer foam of the self-supporting heat-insulating panels and of the tiles of polymer foam of the self-supporting heat-insulating blocks. Thus, a tolerance of +/−5 kg/m³ may be used with respect to the value given to the density.

According to one embodiment, at least one self-supporting heat-insulating panel comprises a block of polymer foam made of rigid polyurethane and a plywood plate positioned on top of the block of polymer foam. It is understood that one or more or all of the self-supporting heat-insulating panels comprise a block of polymer foam made of rigid polyurethane and a plywood plate on which the block of polymer foam rests.

According to one embodiment, at least one self-supporting heat-insulating block comprises a tile of polymer foam made of rigid polyurethane and a plywood plate that is positioned on top of the tile of polymer foam. It is understood that one or more or all of the self-supporting heat-insulating blocks comprise a tile of polymer foam made of rigid polyurethane and a plywood panel on which the tile of polymer foam rests.

The invention also relates to a gravity platform, especially for the storage of a liquefied gas, comprising a liquefied gas storage tank according to one or more preceding features and a suction member of a pump configured to discharge the liquefied gas contained inside the tank from the drain. In other words, the gravity platform comprises a loading and/or unloading tower equipped with at least one pumping member which opens into the drain.

According to one embodiment, the tank comprises a support structure of the tank, the support structure being made of concrete.

The invention also proposes a transfer system for a liquefied gas, the system comprising a gravity platform according to one or more preceding features, insulated pipes arranged so as to connect the tank installed in the support structure of the gravity platform to a ship and a pump for driving a flow of liquefied gas product through the insulated pipes from the tank of the gravity platform to the ship.

The invention further provides a method for loading or unloading a gravity platform according to one or more of the preceding features, wherein a liquefied gas is conveyed through insulated pipes from the tank of a gravity platform to a ship.

Other features and advantages of the invention will appear both from the description which follows and from several exemplary embodiments, which are given for illustrative purposes and without limitation with reference to the appended schematic drawings, in which:

FIG. 1 is a schematic perspective view of a liquefied gas storage tank for a gravity platform comprising a bottom wall according to the invention;

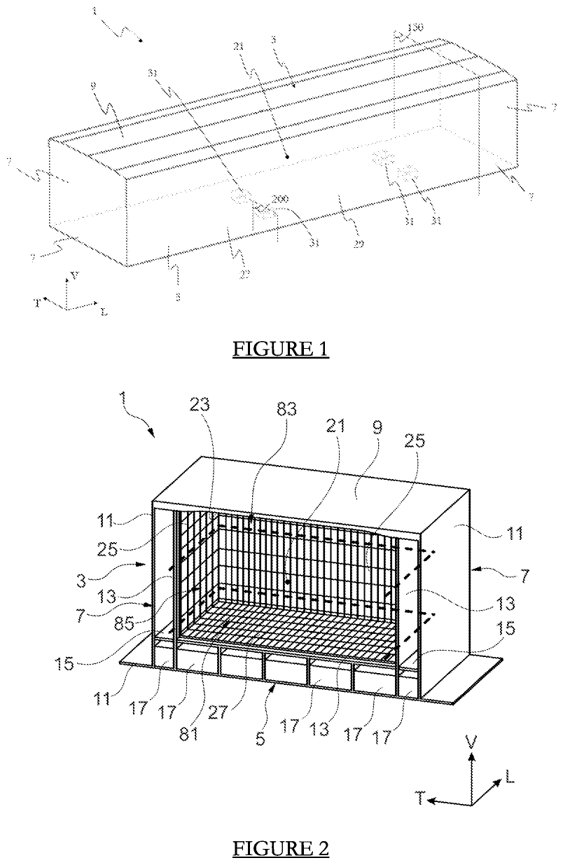

FIG. 2 is a schematic perspective view of a section along a transverse and vertical plane of the tank of FIG. 1;

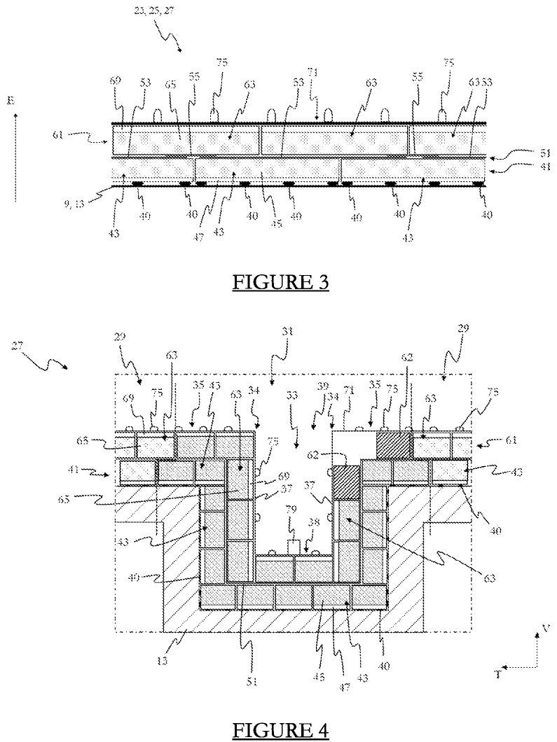

FIG. 3 is a schematic view of a structure of a wall of the tank of FIG. 1, in a direction of the thickness of the wall, in a first embodiment;

FIG. 4 is a schematic view of a drain of the bottom wall of FIG. 1 according to a transverse and vertical sectional plane;

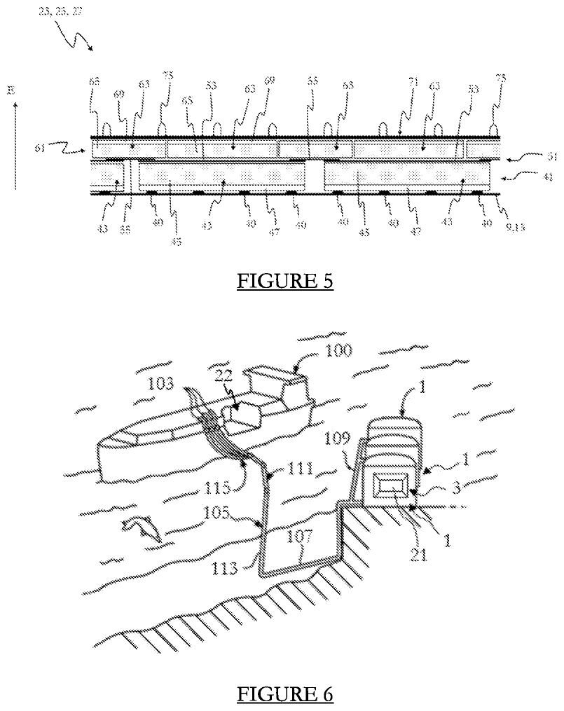

FIG. 5 is a schematic view of a structure of a wall of the tank of FIG. 1, in a direction of the thickness of the wall, in a second embodiment;

FIG. 6 is a schematic depiction of a tank of a gas tanker and a gravity loading/unloading platform comprising the tank according to the invention.

It should first of all be noted that while the figures set out the invention in detail for its implementation, they may of course be used to better define the invention where appropriate. It should also be noted that, in all of the figures, similar elements and/or elements fulfilling the same function are indicated by the same numbering.

In the following description, a direction of a longitudinal axis L, a direction of a transverse axis T, and a direction of a vertical axis V are represented by a trihedron (L, V, T) in the figures. A horizontal plane is defined as being a plane perpendicular to the vertical axis, a longitudinal plane as being a plane perpendicular to the transverse axis, and a transverse plane as being a plane perpendicular to the longitudinal axis.

The terms “external” and “internal” are used to define the relative position of one element with respect to another, with reference to the inside and the outside of the tank.

In the embodiment shown in FIG. 1, the gravity platform 1 comprises a concrete base structure 3 forming a support structure for a sealed and thermally insulating tank 21 for transporting and/or storing a liquefied gas. Hereinafter “base structure” and “support structure” are used interchangeably and designated by the same reference number.

A liquefied gas is a substance or a mixture of substances provided in gaseous form under normal temperature and pressure conditions. A liquefied gas may for example be a liquefied petroleum gas, a liquefied natural gas or an alkane such as ethane.

Referring to FIG. 1 and in FIG. 2, the base structure 3 comprises a double bottom partition 5, an upper partition 9 and double side partitions 7 connecting the double bottom partition 5 to the upper partition 9. Each double partition 5, 7 comprises an external partition 11 and an internal partition 13 made of concrete. The internal partitions 13 and the upper partition 9 define the general shape of the tank 21. The external partitions 11 and the internal partitions 13 are connected to one another by concrete spacers 15.

As shown in FIG. 2, which is a cross-sectional view of the tank 21 along the section plane 150, a lower part of the base structure 3 comprises ballast compartments 17. The ballast compartments 17 are arranged between the internal partition 13 and the external partition 11 of the double bottom partition 5. The ballast compartments 17 are filled with seawater when the gravity platform 1 is located at the location of its operation so as to submerge the gravity platform 1 by ballasting. As a result, the gravity platform 1 rests partly on a seabed.

The tank 21 comprises a plurality of walls 23, 25, 27 which are each arranged against an internal partition 13 and the upper partition 9 of the base structure 3. Thus, the tank 21 comprises an upper wall 23 arranged on an internal face of the upper partition 9 and a bottom wall 27 arranged on an internal face of the internal partition 13. The upper wall 23 and the bottom wall 27 extend in a main plane substantially parallel to the horizontal plane as previously defined. The upper wall 23 is substantially parallel and not secant to the bottom wall 27.

The upper wall 23 and the bottom wall 27 are connected to one another by side walls 25 arranged on an internal face of the other internal partitions 13. The side walls 25 each extend in a plane substantially perpendicular to the horizontal plane from one end of the bottom wall 27 to one end of the upper wall 23. The tank 21 has a generally rectangular parallelepiped shape.

Referring to FIG. 1, the bottom wall 27 comprises at least one first portion 29 at least partially surrounding a second portion 31 of the bottom wall 27. In the embodiment shown in FIG. 1, the first portion 29 surrounds a plurality of second portions 31.

FIG. 4 schematically depicts a second portion 31 of the plurality of second portions 31. The second portion 31 of the bottom wall 27 is thus surrounded by the first portion 29, along the section plane 200 visible in FIG. 1. The second portion 31 comprises a drain 33 surrounded by a bearing 35 which extends from an edge of the drain 33 to the first portion 29. The drain 33 is intended to accommodate a suction member of a pump (not shown) for aspirating or pouring the liquefied gas. The drain 33 comprises a bottom 38 in which is located, for example, a guiding device 79 configured to receive a tower (not shown) for loading and/or unloading the liquefied gas contained in the tank 21. Alternatively, the bottom 38 may be devoid of such a guiding device.

In one embodiment, not shown, the second portion comprises a plurality of drains.

Referring to FIG. 1 and FIG. 4, the first portion 29 of the bottom wall 27 lies in the main plane of extension of the bottom wall 27. More particularly, referring to FIG. 4, the bearing 35 extends in the main plane of extension of the bottom wall 27. The drain 33 has a square-based straight cylindrical shape delimited by side walls 37 which extend in a plane perpendicular to the plane of extension of the bottom wall 27. Thus, an inlet 39 of the drain 33, that is to say an opening through which the liquefied gas present in the tank 21 can reach the inside of this drain 33, is arranged so as to be flush with the first portion 29 of the bottom wall 27.

The first portion 29 and the second portions 31 are connected continuously to form the bottom wall 27. In other words, the first portion 29, the bearings 35 and the drain 33 are connected so that the bottom wall 27 has continuous thermal insulation and continuous leak-tightness.

Referring to FIG. 3 and FIG. 4, each wall 23, 25, 27 comprises, in a direction of the thickness E of the wall 23, 25, 27, a secondary thermally insulating barrier 41 retained in the respective partition of the base structure 3, a secondary leak-tight membrane 51 resting against the secondary thermally insulating barrier 41, a primary thermally insulating barrier 61 resting against the secondary leak-tight membrane 51 and a primary leak-tight membrane 71 intended to be in contact with the liquefied natural gas contained in the tank 21 and resting against the primary thermally insulating barrier 61.

The secondary thermally insulating barriers 41 of the walls 23, 25, 27 of the tank 21 communicate with one another so as to form, between the base structure 3 and the secondary leak-tight membrane 51, a continuous and sealed secondary thermally insulating space. Likewise, the primary thermally insulating barriers 61 of the walls 23, 25, 27 of the tank 21 communicate with one another so as to form, between the secondary leak-tight membrane 51 and the primary leak-tight membrane 71, a continuous and sealed primary thermally insulating space.

Referring to FIG. 3 and FIG. 4, the secondary thermally insulating barrier 41 comprises a plurality of self-supporting heat-insulating blocks 43. The self-supporting heat-insulating blocks 43 have a substantially rectangular parallelepiped shape. The self-supporting heat-insulating blocks 43 may have other shapes such as, for example, a parallelepiped shape, especially with a square or rectangular base, or a straight prism shape with a hexagonal base. The self-supporting heat-insulating blocks 43 are juxtaposed in parallel rows.

In an embodiment not shown, the self-supporting heat-insulating blocks 43 of the plurality of self-supporting heat-insulating blocks 43 may include a corner structure arranged at the junction 34 between the bearing 35 and the drain 33. The corner structure has two pans respectively parallel to the plane of extension of the bearing 35 and to the plane of extension of the side walls 37. The two pans form a dihedral angle of 45° or 90°.

The self-supporting heat-insulating blocks 43 each comprise a heat-insulating tile of polymer foam 45 resting on an external rigid plate 47. The rigid external plate 47 is, for example, a plywood plate. The external rigid plate 47 is bonded to said heat-insulating tile of polymer foam 45. The heat-insulating polymer foam may especially be a rigid polyurethane foam. Glass fibers may be embedded in the polyurethane foam in order to reinforce the mechanical strength of the polymer foam and to reduce the thermal expansion coefficient of the polymer foam. In one embodiment not shown, the rigid external plate 47 is made of at least one composite material.

The self-supporting heat-insulating blocks 43 have a thickness comprised between 100 mm and 350 mm, preferentially between 150 mm and 300 mm, the thickness of the self-supporting heat-insulating blocks 43 being measured parallel to the direction of the thickness E of the wall 23, 25, 27. The density of the heat-insulating tiles of polymer foam 45 varies from one self-supporting heat-insulating block 43 to another according to their arrangement in the tank 21 so as to optimize the mechanical strength and production costs. The variation in the density of the heat-insulating tiles of polymer foam 45 will be detailed below.

The internal face of the internal partitions 13 and the internal face of the upper partition 9 may deviate significantly with respect to the theoretical surface intended for the base structure due, for example, to manufacturing inaccuracies. These deviations are corrected by pressing the self-supporting heat-insulating blocks 43 against the base structure via strips of polymerizable resin 40. The self-supporting heat-insulating blocks 43 are anchored to the internal partitions 13 and to the upper partition 9 by means of studs, not shown, welded onto the internal face of the internal partitions 13.

The secondary leak-tight membrane 51 comprises a plurality of rigid sealed webs 53 made from an aluminum sheet with a thickness of 0.07 mm sandwiched between two fiberglass fabrics impregnated with a polyamide resin. The rigid sealed webs 53 are bonded to the tiles of polymer foam 45 of the self-supporting heat-insulating blocks 43, for example using a two-component polyurethane glue.

In order to impart a certain degree of flexibility to the secondary membrane and to ensure the continuity thereof between two contiguous rigid sealing sheets 53, a flexible sealed web 55 is put into place bonded to adjacent peripheral rims of two contiguous rigid sealing sheets 53. The flexible sealed web 55 is made of a composite material comprising three layers: the two external layers are fiberglass fabrics and the intermediate layer is a thin metal sheet, for example an aluminum foil with a thickness of about 0.1 mm. This metal sheet ensures the continuity of the secondary leak-tight membrane.

The primary thermally insulating barrier 61 comprises a plurality of self-supporting heat-insulating panels 63 having a substantially rectangular parallelepiped shape. The self-supporting heat-insulating panels 63 may have other shapes such as, for example, a cubic shape. In a first embodiment shown in FIG. 3, the self-supporting heat-insulating panels 63 are offset with respect to the self-supporting heat-insulating blocks 43 of the secondary thermally insulating barrier 41 such that each self-supporting heat-insulating panel 63 extends over at least two self-supporting heat-insulating blocks 43.

Each self-supporting heat-insulating panel 63 has a heat-insulating block of polymer foam 65, for example based on rigid polyurethane. A first side of the block of polymer foam 65 is bonded to the secondary leak-tight membrane 51 and a second side, opposite to the first side, is coated with an internal rigid plate 69. The internal rigid plate 69 of the self-insulating panel 63 is for example made of plywood. Glass fibers may be embedded in the polymer foam in order to reinforce it so as to reinforce the mechanical strength of the polymer foam and to reduce the thermal expansion coefficient of the polymer foam. In one embodiment not shown, the internal rigid plate 69 is made of at least one composite material.

The self-supporting heat-insulating panels 63 have a thickness comprised between 100 mm and 200 mm, preferentially between 100 mm and 150 mm, the thickness of the self-supporting heat-insulating panels 63 being measured parallel to the direction of the thickness E of the wall 23, 25, 27.

In a second embodiment depicted in FIG. 5, the self-supporting heat-insulating panels 63 are arranged differently compared to the first embodiment. In other words, in the second embodiment, the elements of the tank are identical to the elements of the first embodiment and only the arrangement of the self-supporting heat-insulating panels 63 with respect to the self-supporting heat-insulating blocks 43 has changed.

Thus, a part of the self-supporting heat-insulating panels 63 is bonded to a central part of self-supporting heat-insulating blocks 43 during pre-fabrication. This part of the self-supporting heat-insulating panels 63 covers a part of the secondary leak-tight membrane 51. Another part of the self-supporting heat-insulating panels 63 is bonded to a periphery of the self-supporting heat-insulating blocks 43. The other part of the self-supporting heat-insulating panels 63 then extends over at least two self-supporting heat-insulating blocks 43.

As shown in FIG. 4, the primary thermally insulating barrier 61 may further comprise angle reinforcements 62 which are used to fill any spaces between the self-supporting heat-insulating panels 63 and the primary leak-tight membrane 71, especially at the junction 34 between the bearing 35 and the drain 33. The angle reinforcements 62 are for example blocks of solid wood or plywood.

The primary leak-tight membrane 71 comprises a plurality of metal sheets which are welded to one another. In the embodiment shown in FIG. 3 and in FIG. 4, the primary leak-tight membrane 71 has corrugations 75 on the metal sheets which allow it to deform under the effect of the thermal and mechanical strains generated by the liquefied gas in the tank 21. The primary leak-tight membrane 71 comprises two series of corrugations 75 perpendicular to one another. The corrugations 75 project toward the inside of the tank 21. The internal rigid plate 69 of each self-supporting heat-insulating panel 63 is equipped with metal plates (not shown) for anchoring the corrugated metal sheets of the primary leak-tight membrane 71. The assembly plates can be assembled together, for example, by welding.

Depending on their location in the tank, the tiles of polymer foam 45 of the self-supporting heat-insulating blocks 43 and/or the blocks of polymer foam 65 of the self-supporting heat-insulating panels 63 may have a different density, depending on their location in the tank 21. This makes it possible to reinforce the locations of the tank 21 that undergo high mechanical stresses while minimizing the costs of manufacturing such a tank.

Thus, the density of the tiles of polymer foam 45 and the density of the blocks of polymer foam 65 of the second portion 31 of the bottom wall 27 is greater than the density of the tiles of polymer foam 45 and the density of the blocks of polymer foam 65 of the first portion 29 of the bottom wall 27.

In the embodiment shown in the figures, the density of the tiles of polymer foam 45 of the drain 33 and of the bearing 35 and the density of the blocks of polymer foam 65 of the drain 33 and of the bearing 35 are substantially equal to 130 kg/m³. Therefore, the density of the tiles of polymer foam 45 of the second portion 31 is substantially equal to the density of the blocks of polymer foam 65 of the second portion 31. The density of the tiles of polymer foam 45 and the density of the blocks of polymer foam 65 of the first portion 29 is equal to 90 kg/m³. It is understood that the density of the tiles of polymer foam 45 of the first portion 29 is substantially equal to the density of the blocks of polymer foam 65 of the first portion 29.

In an embodiment not shown, the tiles of polymer foam 45 of the first portion 29 have a density different from the density of the blocks of polymer foam 65 of the first portion 29. In an embodiment not shown, the tiles of polymer foam 45 of the second portion 31 have a density different from the density of the blocks of polymer foam 65 of the second portion 31.

Referring to FIG. 2 and FIG. 4, the density of the blocks of polymer foam 65 of the self-supporting heat-insulating panels 63 decreases in a direction from the bottom wall 27 toward the upper wall 23. Furthermore, the density of the tile of polymer foam 45 of the self-supporting heat-insulating blocks 43 decreases in a direction from the bottom wall 27 toward the upper wall 23.

More precisely, the tank 21 comprises a first zone 81, a second zone 83 and at least one third zone 85. The first zone 81 comprises the bottom wall 27 and a lower part of the side walls 25. The second zone 83 comprises the upper wall 23 and an upper part of the side walls 25. The third zone 85 comprises a central part of the side walls 25. In this context, the third zone 85 is sandwiched between the first zone 81 and the second zone 83.

The tiles of polymer foam 45 and the blocks of polymer foam 65 of the first zone 81 have a density greater than or equal to 90 kg/m³. The tiles of polymer foam 45 and the blocks of polymer foam 65 of the lower part of the side walls 25 have a density substantially equal to 90 kg/m³. As previously described, the tiles of polymer foam 45 and the blocks of polymer foam 65 of the first portion 29 have a density substantially equal to 90 kg/m³. The tiles of polymer foam 45 and the blocks of polymer foam 65 of the second portion 31 have a density substantially equal to 130 kg/m³.

The density of the tiles of polymer foam 45 and the density of the blocks of polymer foam 65 of the second zone 83 are substantially equal to 65 kg/m³. The density of the tiles of polymer foam 45 of the second zone 83 and the density of the blocks of polymer foam 65 of the second zone 83 are therefore less than 70 kg/m³.

The density of the tiles of polymer foam 45 and the density of the blocks of polymer foam 65 of the third zone 85 are substantially equal to 75 kg/m³. The density of the tiles of polymer foam 45 and the density of the blocks of polymer foam 65 of the third zone 85 are therefore comprised between 65 kg/m³ and 90 kg/m³. In other words, the density of the tiles of polymer foam 45 of the third zone 85 is comprised between the values of the density of the tiles of polymer foam 45 of the second zone 83 and the value of the density of the tiles of polymer foam 45 of the first zone 81. Furthermore, the density of the blocks of polymer foam 65 of the third zone 85 is comprised between the values of the density of the blocks of polymer foam 65 of the second zone 83 and the value of the density of the blocks of polymer foam 65 of the first zone 81.

In an embodiment not shown, the tank comprises a plurality of third zones 85 sandwiched between the first zone 81 and the second zone 83. The third zones 85 are then stacked in a direction from the bottom wall 27 toward the upper wall 23.

The blocks of polymer foam 65 of the self-supporting heat-insulating panels 63 of one third zone of the plurality of third zones 85 having a substantially identical density. In other words, the density of the blocks of polymer foam 65 of the self-supporting heat-insulating panels 63 is uniform within a single third zone 85.

The density of the blocks of polymer foam 65 of the self-supporting heat-insulating panels 63 of the plurality of third zones 85 decreasing in a direction from the bottom wall 27 toward the upper wall 23. The density of the blocks of polymer foam 65 of the self-supporting heat-insulating panels 63 is therefore different from one third zone to another third zone. The density of the blocks of polymer foam 65 of the self-supporting heat-insulating panels 63 of the third zone 85 closest to the bottom wall 27 is greater than the density of the blocks of polymer foam 65 of the self-supporting heat-insulating panels 63 of the third zone 85 closest to the upper wall 23.

In this embodiment not shown, the tiles of polymer foam 45 of the self-supporting heat-insulating blocks 43 of one third zone of the plurality of third zones 85 having a substantially identical density. In other words, the density of the tiles of polymer foam 45 of the self-supporting heat-insulating blocks 43 is uniform within a single third zone 85.

The density of the tiles of polymer foam 45 of the self-supporting heat-insulating blocks 43 of the plurality of third zones 85 decreasing in a direction from the bottom wall 27 toward the upper wall 23. The density of the tiles of polymer foam 45 of the self-supporting heat-insulating blocks 43 is therefore different from one third zone to another third zone. The density of the tiles of polymer foam 45 of the self-supporting heat-insulating blocks 43 of the third zone 85 closest to the bottom wall 27 is greater than the density of the tiles of polymer foam 45 of the self-supporting heat-insulating blocks 43 of the third zone 85 closest to the upper wall 23.

Preferentially, the tank 21 comprises three third zones 85, thus the tank 21 comprises five zones 81, 83, 85.

FIG. 6 shows the transport and/or storage tank 21 having a generally parallelepiped shape mounted in the base structure 3 of a gravity platform 1. Gravity platforms 1 are generally offshore structures used in the context of oil or gas production. These structures often have a concrete base structure, referred to using the term GBS (Gravity Based Structure); the term SGS (Steel Gravity Structure) is also used for a base structure made of steel, to which the invention also applies.

Gravity platforms 1 can simultaneously serve as a bund, storage, platform for receiving a liquefaction plant and loading dock in the context of a field for producing liquefied gas such as, for example, liquefied natural gas or ethane.

The wall of the tank 21 comprises a primary sealed membrane that is intended to be in contact with the LNG contained in the tank 21, a secondary sealed membrane that is arranged between the primary sealed barrier and the base structure 3 of the gravity platform 1, and two thermally insulating barriers that are arranged between the primary sealed barrier and the secondary sealed barrier and between the secondary sealed barrier and the base structure 3, respectively. In an inherently known manner, loading/unloading pipes 103 that are arranged on the upper deck of a gas tanker 100 can be connected, by means of suitable connectors, to the gravity platform 1 in order to transfer an LNG cargo from or to the tank 21.

FIG. 6 also shows the gravity platform 1 comprising a loading and unloading station 105, an underwater pipe 107, and a gravity platform 1. The loading and unloading station 105 is a secured offshore installation comprising a moving arm 111 and a tower 113 that supports the moving arm 111. The moving arm 111 carries a bundle of insulated flexible hoses 115 that can be connected to the loading/unloading pipes 103. The adjustable moving arm 111 adapts to all sizes of gas tankers. A connecting pipe, not shown, extends inside the tower 113. The loading and unloading station 105 allows the loading and unloading of at least one tank 22 of the gas tanker 100 from or to the gravity platform 1. The tank 22 of the gas tanker 100 can be a tank according to the invention. The gravity platform 1 comprises at least one liquefied gas storage tank 21 according to the invention and connecting pipes 109 connected by the underwater pipe 107 to the loading or unloading station 105. The underwater pipe 107 allows the transfer of the liquefied gas between the loading or unloading station 105 and the gravity platform 1 over a great distance, for example 5 km, which makes it possible to keep the gas tanker 100 at a great distance from the coast during loading and unloading operations. In order to generate the pressure necessary for the transfer of the liquefied gas, pumps on board the gas tanker 100 and/or pumps fitted to the gravity platform 1 and/or pumps fitted to the loading and unloading station 105 are used.

The invention thus makes it possible to simply produce a tank 21 for storing and/or transporting liquefied gas for a gravity platform 1 having increased mechanical strength especially at a drain 33 provided in a bottom wall 27 of the tank 21 by using tiles of polymer foam 45 of self-supporting heat-insulating blocks 43 and blocks of polymer foam 65 of the self-supporting heat-insulating panels 63 with different density within the bottom wall 27. Furthermore, by varying the density of the tiles of polymer foam 45 of the self-supporting heat-insulating blocks 43 and by varying the blocks of polymer foam 65 of the self-supporting heat-insulating panels 63 according to a height of the tank 21, it is possible to minimize the costs of manufacturing the tank 21.

Of course, the invention is not limited to the examples that have just been described, and numerous modifications can be made to these examples without departing from the scope of the invention.

1. A tank for transporting and/or storing a liquefied gas, comprising: a plurality of walls each comprising, in a direction of the thickness of the wall, a thermally insulating barrier and at least one leak-tight membrane that rests against the thermally insulating barrier and is intended to be in contact with the liquefied gas inside the tank, the thermally insulating barrier comprising a plurality of self-supporting heat-insulating panels which each comprise a block of polymer foam and at least one plate, a bottom wall of the plurality of walls comprises at least one first portion at least partially surrounding a second portion of the bottom wall, the second portion comprising at least one drain, wherein the blocks of polymer foam of the second portion have a density greater than a density of the blocks of polymer foam of the first portion.

2. The tank according to claim 1, wherein the plurality of walls comprises an upper wall and side walls connecting the bottom wall to the upper wall, the density of the blocks of polymer foam of the self-supporting heat-insulating panels decreasing from the bottom wall to the upper wall.

3. The tank according to claim 1, wherein the plurality of walls comprises an upper wall and side walls connecting the bottom wall to the upper wall, the density of the blocks of polymer foam of the self-supporting heat-insulating panels of the first portion being substantially equal to the density of the blocks of polymer foam of the self-supporting heat-insulating panels of the side walls and substantially equal to the density of the blocks of polymer foam of the self-supporting heat-insulating panels of the upper wall.

4. The tank according to claim 2, comprising a first zone formed by the bottom wall and by a lower part of the side walls, as well as a second zone formed by the upper wall and by an upper part of the side walls, and wherein the density of the blocks of polymer foam of the self-supporting heat-insulating panels of the first zone is greater than the density of the blocks of polymer foam of the self-supporting heat-insulating panels of the second zone.

5. The tank according to claim 4, comprising at least one third zone inserted between the first zone and the second zone and wherein the density of the blocks of polymer foam of the self-supporting heat-insulating panels of the third zone is comprised between the density of the blocks of polymer foam of the self-supporting heat-insulating panels of the first zone and the density of the blocks of polymer foam of the self-supporting heat-insulating panels of the second zone.

6. The tank according to claim 5, comprising a plurality of third zones, the third zones being stacked in a direction from the bottom wall toward the upper wall, the blocks of polymer foam of the self-supporting heat-insulating panels of one third zone of the plurality of third zones having a substantially identical density, and the density of the blocks of polymer foam of the self-supporting heat-insulating panels of the plurality of third zones decreasing in the direction from the bottom wall toward the upper wall.

7. The tank according to claim 1, wherein the leak-tight membrane is a primary leak-tight membrane and the thermally insulating barrier is a primary thermally insulating barrier, and wherein the bottom wall comprises a secondary leak-tight membrane and a secondary thermally insulating barrier which comprises a plurality of self-supporting heat-insulating blocks comprising tiles of polymer foam and at least one plate, the secondary leak-tight membrane rests against the secondary thermally insulating barrier, the primary thermally insulating barrier rests against the secondary leak-tight membrane and the primary leak-tight membrane rests against the primary thermally insulating barrier.

8. The tank according to claim 7, wherein the tiles of polymer foam of the self-supporting heat-insulating blocks of the second portion of the bottom wall have a greater density than the tiles of polymer foam of the self-supporting heat-insulating blocks of the first portion of the bottom wall.

9. The tank according to claim 7, wherein the tiles of polymer foam of the self-supporting heat-insulating blocks of the second portion of the bottom wall have a density substantially equal to the density of the blocks of polymer foam of the self-supporting heat-insulating panels of the second portion of the bottom wall.

10. The tank according to claim 7, wherein the density of the tiles of polymer foam of the self-supporting heat-insulating blocks of the first portion of the bottom wall is less than or equal to 110 kg/m³ and the density of the tiles of polymer foam of the self-supporting heat-insulating blocks of the second portion of the bottom wall is greater than or equal to 115 kg/m³.

11. The tank according to claim 1, wherein the plurality of walls comprises an upper wall and side walls connecting the bottom wall to the upper wall, and wherein the upper wall and the side walls each comprise a secondary leak-tight membrane and a secondary thermally insulating barrier which comprises a plurality of self-supporting heat-insulating blocks comprising tiles of polymer foam and at least one plate, the secondary leak-tight membrane rests against the secondary thermally insulating barrier, the primary thermally insulating barrier rests against the secondary leak-tight membrane and the primary leak-tight membrane rests against the primary thermally insulating barrier, the density of the tiles of polymer foam of the self-supporting heat-insulating blocks, decreasing from the bottom wall to the upper wall.

12. The tank according to claim 7, wherein the tiles of polymer foam of the self-supporting heat-insulating blocks of the first portion, of the side walls and of the upper wall have a density substantially equal to the density of the blocks of polymer foam of the self-supporting heat-insulating panels of the first portion, of the side walls and of the upper wall and wherein the tiles of polymer foam of the self-supporting heat-insulating blocks of the second portion have a density substantially equal to the density of the blocks of polymer foam of the self-supporting heat-insulating panels of the second portion.

13. The tank according to claim 1, wherein the bottom wall comprises a plurality of second portions.

14. A gravity platform comprising a liquefied gas storage tank according to claim 1 and a pump suction member configured to discharge the liquefied gas contained inside the tank from the drain.

15. The gravity platform according to claim 14, comprising a support structure of the tank, the support structure being made of concrete.

16. A transfer system for a liquefied gas, the system comprising a gravity platform according to claim 14, insulated pipes arranged so as to connect the tank installed in the support structure of the gravity platform to a ship and a pump for driving a flow of liquefied gas through the insulated pipes from the tank of the gravity platform to the ship.

17. A method for loading or unloading a gravity platform according to claim 14, wherein a liquefied gas is conveyed through insulated pipes from the tank of the gravity platform to a ship.
